(19) United States
(12) Patent Application Publication
(10) Pub. No.: US 2002/0097496 A1
(43) Pub. Date: Jul. 25, 2002

(54) Light redirecting film

(75) Inventor: Xiao-Jing Lu, Bloomfield, CT (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Reflexite Corporation, Avon, CT

(21) Appl. No.: 10/023,204

(22) Filed: Dec. 13, 2001

Related U.S. Application Data
(60) Provisional application No. 60/256,202, filed on Dec. 15, 2000.

(51) Int. Cl. G02B 27/10

(52) U.S. Cl. 359/628; 359/625; 359/626

(57) ABSTRACT

A sheeting having linear prisms and method for forming the same are provided in which the prism includes a base, a first side, and a second side. In one embodiment, the first side includes a first planar surface and the second side includes a second planar surface and a third planar surface. In another embodiment, the first side includes the first planar surface extending from the base plane to a fourth planar surface which extends to the second planar surface at an apex of the prism. In particular embodiments, at least three of the planar surfaces can have different cross-sectional lengths.

### RELATED APPLICATION

This application claims the benefit of U.S. Provisional Application No. 60/256,202, filed on Dec. 15, 2000, the entire teachings of which are incorporated herein by reference.

### BACKGROUND OF THE INVENTION

Brightness enhancing films (BEF) have been used in lighting panels for directing light from lighting fixtures through luminaires and laptop computer displays. The brightness enhancing films, which can have linear prisms, diffuse light with a desired directionality. Often the films have been used in combination with a fluorescent light source. The films have had partial success in improving luminair or display brightness by controlling the angle at which light emerges. However, a need still exists for improved control of lighting and enhancement of brightness, for example, for use in laptop computer screens and flat panel desktop computer monitor or display.

### SUMMARY OF THE INVENTION

A sheeting having linear prisms and a method for forming the same are provided in which the linear prism includes a base, a first side, and a second side. In one embodiment, the first side includes a first planar surface and the second side includes a second planar surface and a third planar surface. In another embodiment, the first side includes the first planar surface extending from the base plane to a fourth planar surface which extends to the second planar surface at an apex of the linear prism. In particular embodiments, at least three of the planar surfaces can have different cross-sectional lengths.

An advantage of the three-sided and four-sided prisms is that the amount of light that can be collimated from a wider range of angles is greater than that can be collimated with a two-sided prism. Also, the three-sided prism allows for improved collimating of light that is incoming from a light source at an angle off to a side than with a two-sided prism. The structure can be used in interior and exterior lighting applications in addition to computer screens.

### BRIEF DESCRIPTION OF THE DRAWINGS

The foregoing and other objects, features and advantages of the invention will be apparent from the following more particular description of embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a back light display device in accordance with the present invention.

FIG. 2 is a cross-sectional view of the collimating film of FIG. 1 illustrating light rays, emanating from a point source, being redirected by the film.

FIG. 3 is a cross-sectional view of the collimating film of FIG. 1 illustrating light rays, emanating from multiple point sources, being, redirected by the film.

FIG. 4 is a cross-sectional view of one embodiment of a linear prism having multi-planar facets in accordance with the present invention.

FIG. 5 is a cross-sectional view of another embodiment of a linear prism having multi-planar facets in accordance with the present invention.

FIG. 6 is a cross-sectional view of yet another embodiment of a linear prism having multi-planar facets in accordance with the present invention.

FIG. 7 is a cross-sectional view of a further embodiment of a linear prism having multi-planar facets in accordance with the present invention.

FIG. 8 is a cross-sectional view of one embodiment of a linear prism having three planar facets in accordance with the present invention.

FIG. 9 is a cross-sectional view of another embodiment of a linear prism having three planar facets in accordance with the present invention.

FIG. 10 is a polar plot of light distribution for the display device of FIG. 1 in which the linear prisms have a 90 degree included angle.

FIG. 11 is a polar plot of light distribution for the display device of FIG. 1 in which the linear prisms are symmetrical and have multi-planar faceted sides in accordance with one embodiment of the present invention.

FIG. 12 is a polar plot of light distribution for the display device of FIG. 1 in which the linear prisms are non-symmetrical and have multi-planar faceted sides in accordance with another embodiment of the present invention.

FIG. 13 is a polar plot of light distribution for the display device of FIG. 1 in which the linear prisms are symmetrical and have multi-planar faceted sides in accordance with yet another embodiment of the present invention.

FIG. 14 illustrates a setup for testing the optical performance of various linear prisms.

FIG. 15 is a plot illustrating the luminance (candelas/lux/m²) on the y axis versus the pixel position of the charged coupled device (CCD) for typical symmetric linear prisms having about 90 degree apex angles in accordance with the prior art.

FIG. 16 is a plot illustrating the luminance versus the pixel position for a plurality of symmetric linear prisms having about 88 degree apex angles in accordance with the prior art.

FIG. 17 is a plot illustrating the luminance versus the pixel position for a plurality of symmetrical linear prisms having multi-planar facets in which the base angles are about 46 degrees and the apex angles are about 92 degrees in accordance with the present invention.

### DETAILED DESCRIPTION OF THE INVENTION

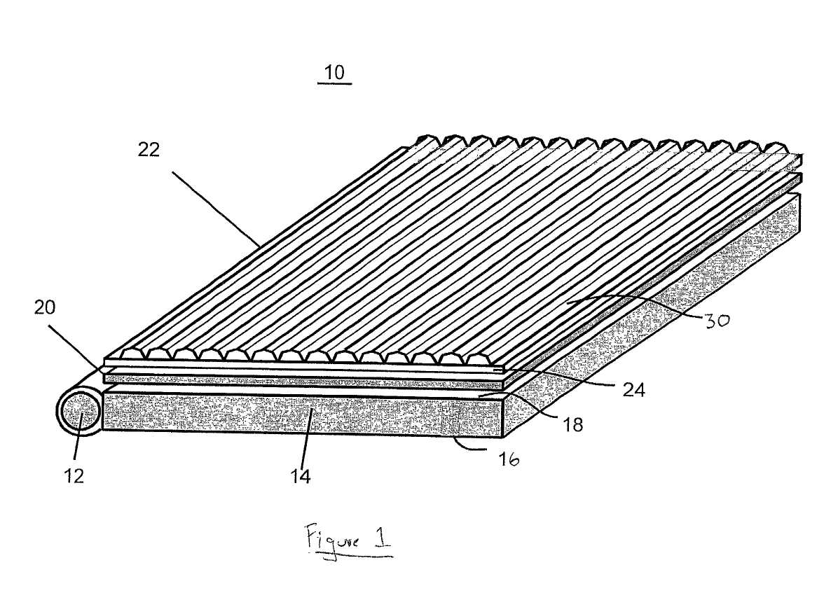

A description of various embodiments of the invention follows. With respect to the optical performance of a collimating film, it has been found that for individual active matrix liquid crystal display (AMLCD) back lighting system designs, the optical efficiency of the particular lamp, waveguide and diffuser system can be improved by designing a collimating film to enhance the use of the diffraction and refraction effects. For example, as shown in FIG. 1, a back lighting system 10 includes a light source 12, such as a fluorescent light, incandescent light or other suitable light source. Waveguide or light guide 14, which is for redirecting light from the light source 12, can be formed of a transparent solid material and can be wedge-shaped. In one embodiment, the bottom surface 16 has a rough surface for redirecting light rays towards the opposing, top smooth surface 18. In alternative embodiments, the bottom surface 16 is smooth and a reflector, which can be formed from a specular material or a coated white surface, is used to reflect light back into the waveguide 14. The light rays pass through a diffuser 20 which uniformly distributes the impinging light rays. An example of a suitable diffuser is a randomly textured surface or gradient index film or engineered diffractive structure.

A collimating film 22 is disposed above the diffuser 20 for collimating the light exiting the diffuser. In one embodiment, the collimating film 22 includes a plurality of linear prisms 30 formed or cast on a substrate 24. In one embodiment, the linear prisms 30 and the substrate 24 are formed from a substantially transparent material, such as polycarbonate, polyester, or other suitable materials. Although the longitudinal axes of the linear prisms 30 are shown to be substantially parallel to the longitudinal axes of the light source 12, the longitudinal axes of the linear prisms 30 can be disposed at any angle relative to the longitudinal axis of the light source, such as 90 degrees offset.

A second collimating film having a plurality of linear prisms formed on a substrate can be disposed above the first collimating film 22. In one embodiment, the second collimating film is disposed such that the longitudinal axes of the linear prisms are about 90 degrees offset relative to the longitudinal axes of the linear prisms 30 to reduce moiré fringe formation and improve the uniformity of the exiting light distribution. A second diffuser can be disposed above the second collimating film.

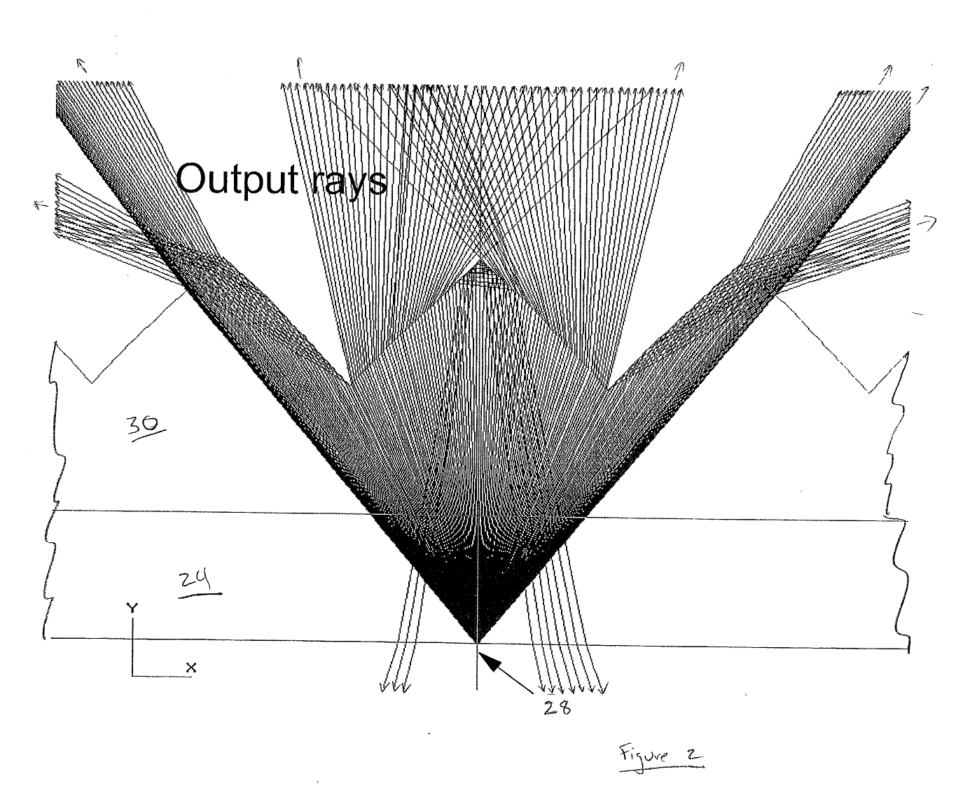

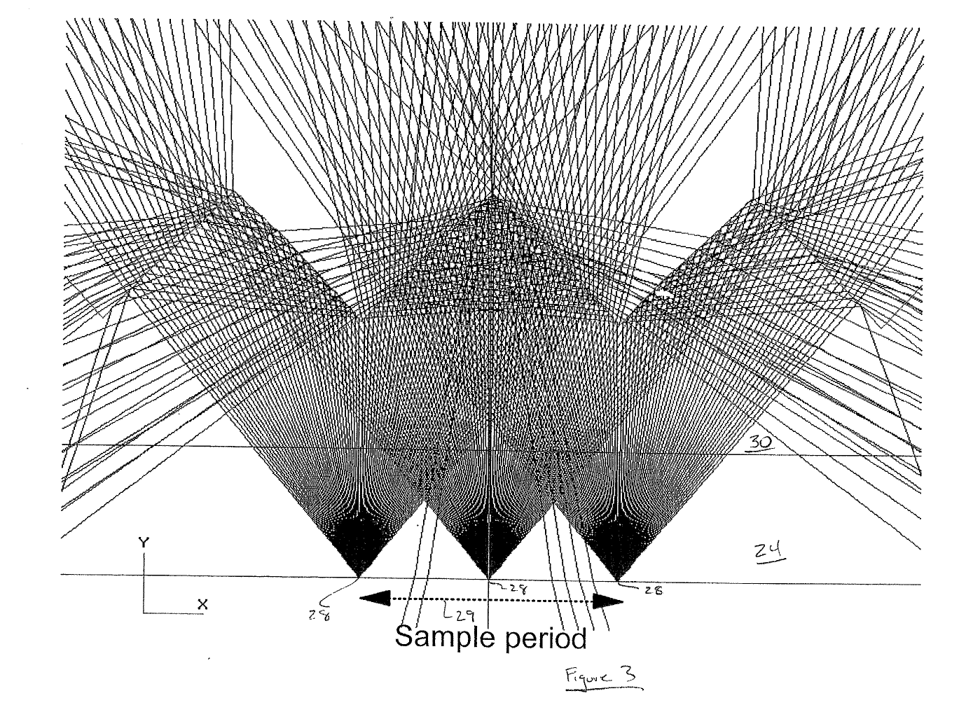

FIG. 2 illustrates the light rays, emanating from a point source 28, passing through the substrate 24 and being redirected by the linear prisms 30 in a desired direction, such as much more normal to the base plane 32. FIG. 3 is similar to FIG. 2 and illustrates a sampling process. The sample length 29 is an elemental length of the collimating film 22 that corresponds to the pitch, or peak-to-peak or groove-to-groove distance. As shown, there are three point light sources 28 in the sample length 29. One point source 28 is in the center of the sample length, and the other two point sources are on the ends of the sample lengths.

Typical linear prisms include a base plane, a first planar facet or surface, and a second planar facet or surface which meet at an apex and form an included angle, for example, 90 degrees. Thus, a base plane and two planar surfaces are included in each linear prism. The description of a linear prism being n-sided does not include the base plane as one of the sides in the number of sides. For example, a three-sided prism includes a base plane and three other facets or surfaces.

It has been found that providing two or more planar facets on at least one side of the linear prism has resulted in the same or an increased throughput of the light rays through the prisms.

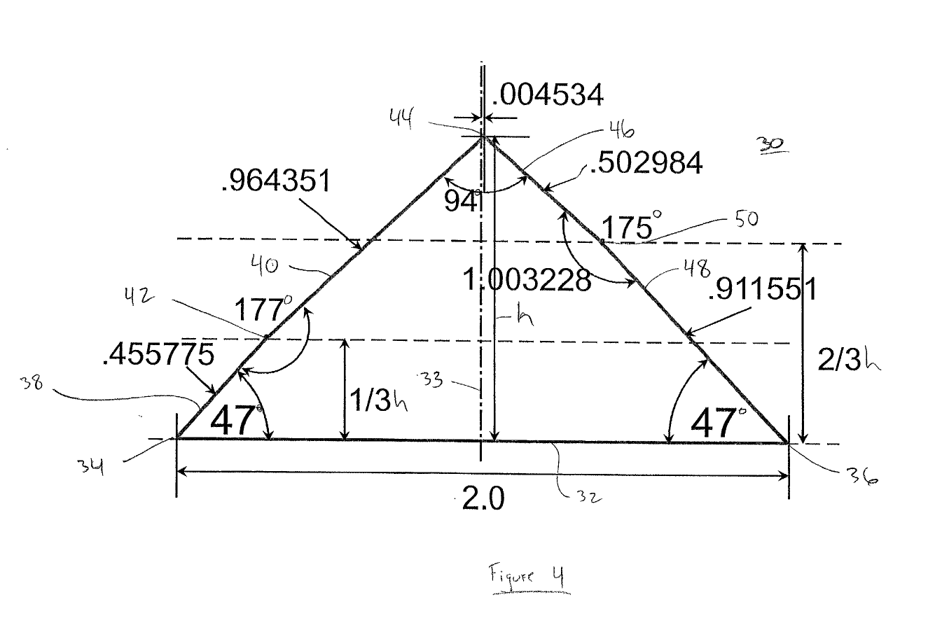

FIG. 4 illustrates one embodiment of a linear prism 30 which has multi-planar facets on two sides. More particularly, a base plane 32 is provided having a first end point 34 and a second end point 36. The first end point and the second end point can be the low points in the valleys between the linear prisms. A first planar facet or surface 38 extends from the end point 34 to intersect a second planar facet or surface 40 at point 42, the second planar facet 40 extending to the apex 44. A third planar facet or surface 46 extends from the apex 44 and intersects the fourth planar facet 48 at point 50. The fourth planar facet or surface 48 extends to the second base point 36. In this particular embodiment, the planar facets 38, 40, 46, and 48 have different cross-sectional lengths, i.e., the prism is asymmetric. The intersecting points 42, 50 are approximately ⅓ and ⅔ the height h of the prism 30 although the points can be anywhere along the sides of the prism including equidistantly along the respective sides. For example, the ratio of the height of the intersection point, e.g., point 42, to the total height h can be in the range of about 0.2 to 0.8. Thus, the four planar facets 38, 40, 46, and 48 can all have the same cross-sectional length or two of the sides, for example, 38, 48 and 40, 46 can have the same cross-sectional length.

In the embodiment shown in FIG. 4, planar facets 38 and 48, form base angles of about 47 degrees with the base plane 32. If the planar facets 38 and 48 were continued linearly, they would form an apex angle of about 86 degrees. However, with the multi-planar facet sides, the planar facets 40, 46 form an apex angle of about 94 degrees. Because the planar facets are unequal in cross-sectional length, the prism is tilted or canted with respect to an optical axis of the prism that intersects the base plane. The tilting angle can range up to about 22 degrees. In this embodiment, the tilting angle is about 0.26 degrees. The dihedral angle of planar facets 38 and 40 is about 177 degrees and the dihedral angle of planar facets 46 and 48 is about 175 degrees. The apex 44 is offset about 0.1143 mm (0.0045 inches) from a center line 33 that is normal to the base plane 32. It is contemplated that many different base and apex angles can be used in accordance with the present invention. As shown, the base plane 32 has a cross-sectional length of about 0.0508 mm (2.0 mils), and the planar facets 38, 40, 46, and 48 have respective cross-sectional lengths of about 0.011576, 0.024494, 0.012776, and 0.023153 mm (0.455775, 0.964351, 0.502984, and 0.911551 mils).

Although both sides of this prism in this embodiment are shown to have multi-planar facets, a prism can also be formed which includes only one side that has a multi-planar side. Thus, a linear prism having at least three planar surfaces can be provided in accordance with the present invention. Additionally, although the linear prism 30 is shown to be convex-shaped, as viewed from the exterior, in alternative embodiments, the linear prism can include one or more concave-shaped sides. Further, the linear prism 30 can include more than two planar facets along one side, i.e., to form a prism having five or more planar facets. Also, the cross-sectional dimensions of the prisms described herein can be varied to provide different throughput of light rays through the prism.

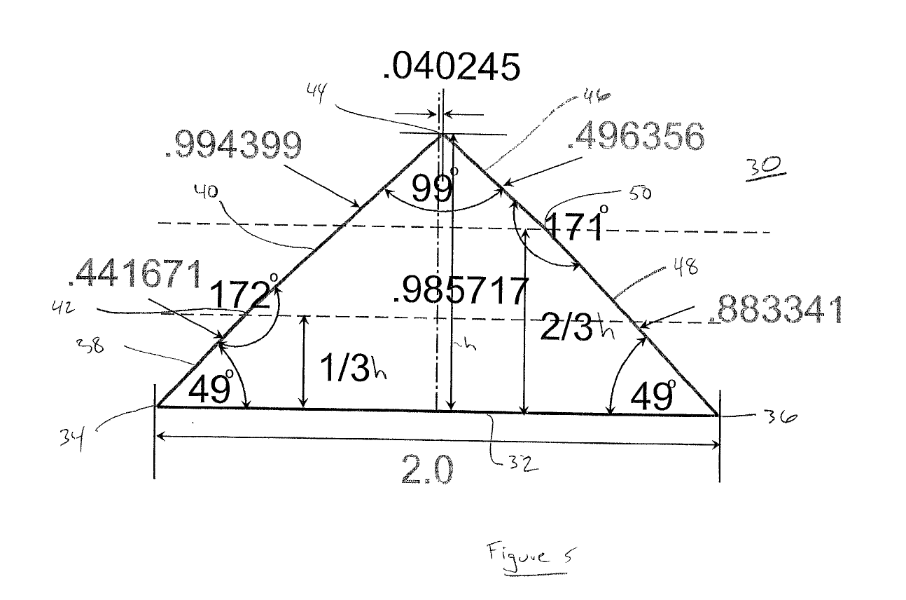

FIG. 5 is similar to FIG. 4 and illustrates another embodiment of a linear prism 30 having multi-planar sides. In this embodiment, the base angles are about 49 degrees and the apex angle is about 99 degrees. The respective dihedral angles of the planar facets 38, 40, 46, 48 are about 177 and 175 degrees. The base plane 32 has a cross-sectional length of about 0.0508 mm (2.0 mils), and the planar facets 38, 40, 46, and 48 have respective cross-sectional lengths of about 0.011218, 0.025257, 0.012607, and 0.022437 mm (0.441671, 0.994399, 0.496356, and 0.883341 mils).

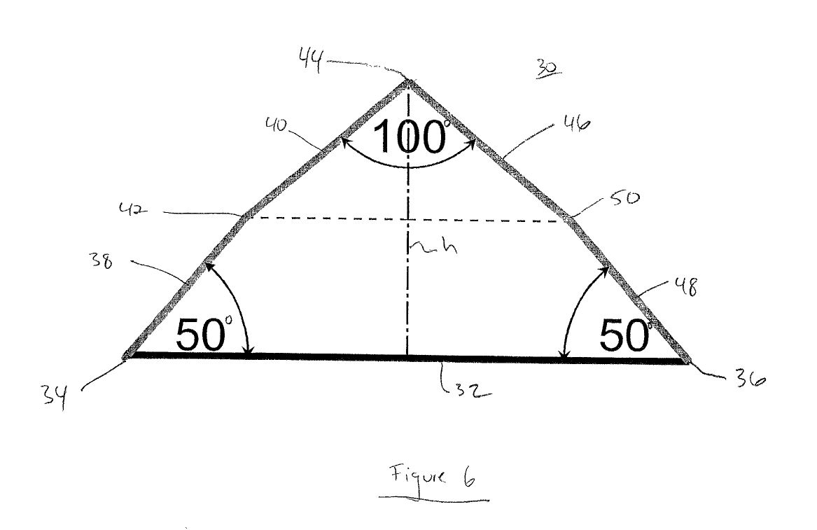

FIG. 6 illustrates a multi-planar faceted prism 30 in which the base angles are about 50 degrees and the apex angle is about 100 degrees. In this embodiment, the prism is not tilted. That is, the points 42, 50 are substantially equidistant from the base plane 32.

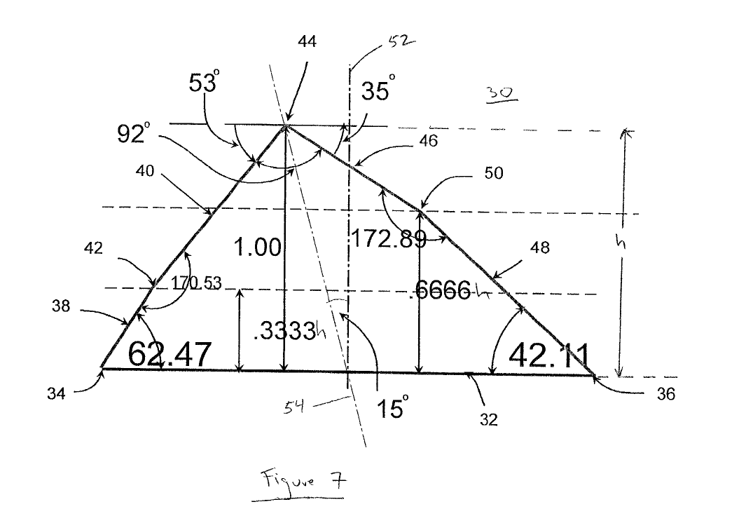

FIG. 7 illustrates a multi-planar faceted prism 30 which is canted at about 15 degrees. That is, the optical axis 54 is offset at about 15 degrees relative to line 52 which is normal to the base plane 32. In this embodiment, the apex angle is about 92 degrees. The base angle formed between the base plane 32 and planar facet 38 is about 62.47 degrees and the base angle formed between the base plane 32 and planar facet 48 is about 42.11 degrees.

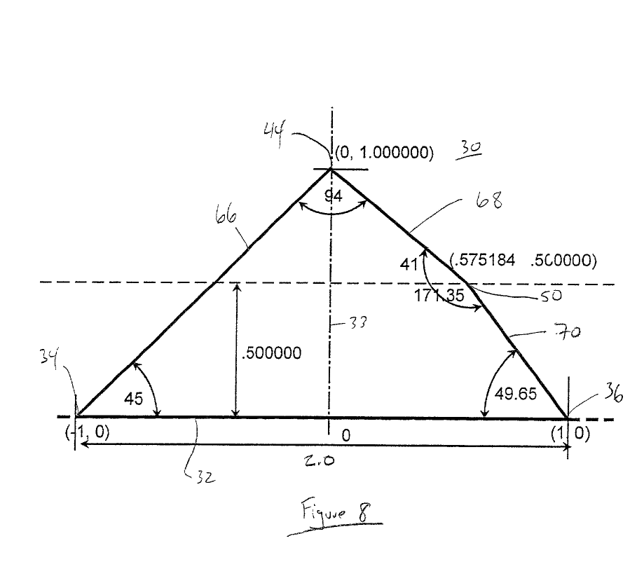

FIG. 8 illustrates an embodiment of a linear prism 30 having three planar facets 66, 68, and 70. The base angle between base plane 32 and facet 66 is about 45 degrees and the base angle between base plane 32 and facet 70 is about 49.65 degrees. The dihedral angle between facets 68 and 70 is about 171.35 degrees. The base plane 32 has a cross-sectional length of about 0.0508 mm (2.0 mils) and the planar facets 66, 68, and 70 have respective cross-sectional lengths of about 0.035921, 0.019358, and 0.016664 mm (1.414213, 0.762126, and 0.656078 mils).

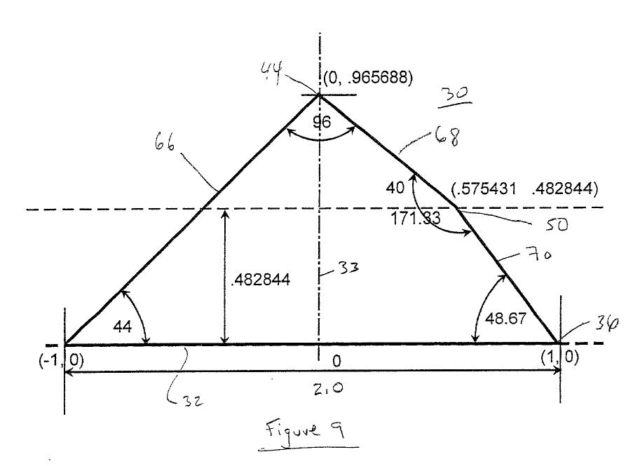

FIG. 9 illustrates another embodiment of a linear prism 30 having three planar facets 66, 68, and 70. The base angle between base plane 32 and facet 66 is about 44 degrees and the base angle between base plane 32 and facet 70 is about 48.67 degrees. The dihedral angle between facets 68 and 70 is about 171.33 degrees. The base plane 32 has a cross-sectional length of about 0.0508 mm (2.0 mils) and the planar facets 66, 68, and 70 have respective cross-sectional lengths of about 0.035310, 0.019073, and 0.016318 mm (1.390163, 0.750912, and 0.642466 mils).

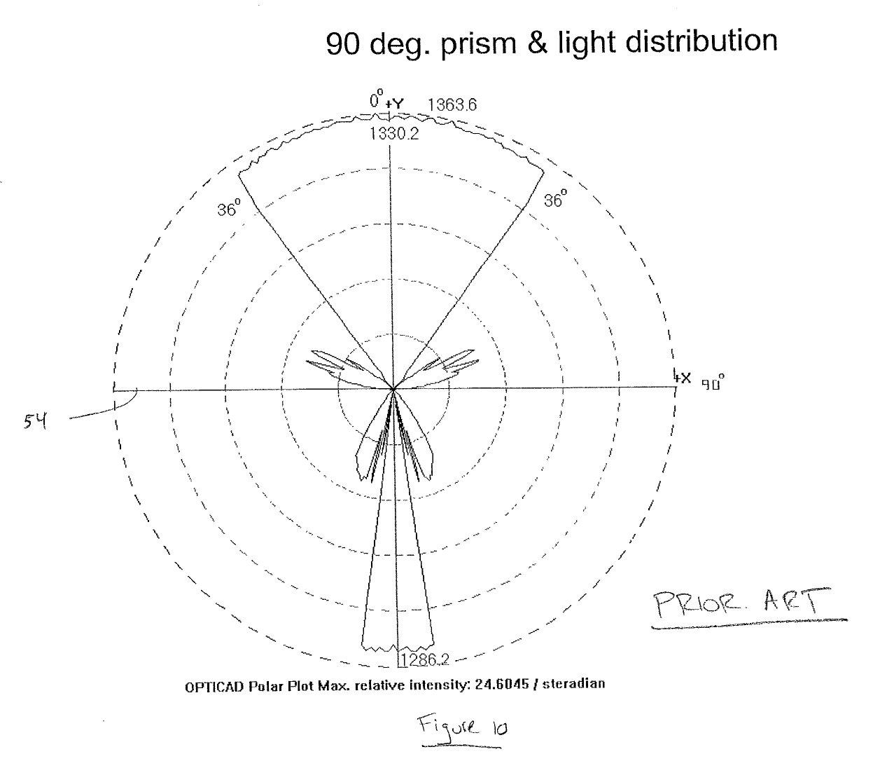

FIG. 10 is a polar plot of light distribution for a display device similar to FIG. 1 in which the linear prisms have only three planar surfaces (base plane and two side, planar facets) and a 90 degree included angle. The light that is transmitted through the collimating film 22 is shown above the horizontal line 54. It is noted that some of the light is reflected downward while most of the light is transmitted through the film 22. The transmitted light has about a 36.5 degree half width at the half luminance value. The central value for the transmitted light is about 1,330.2 candelas/lux/m² while the highest value is about 1,363.6 candelas/lux/m².

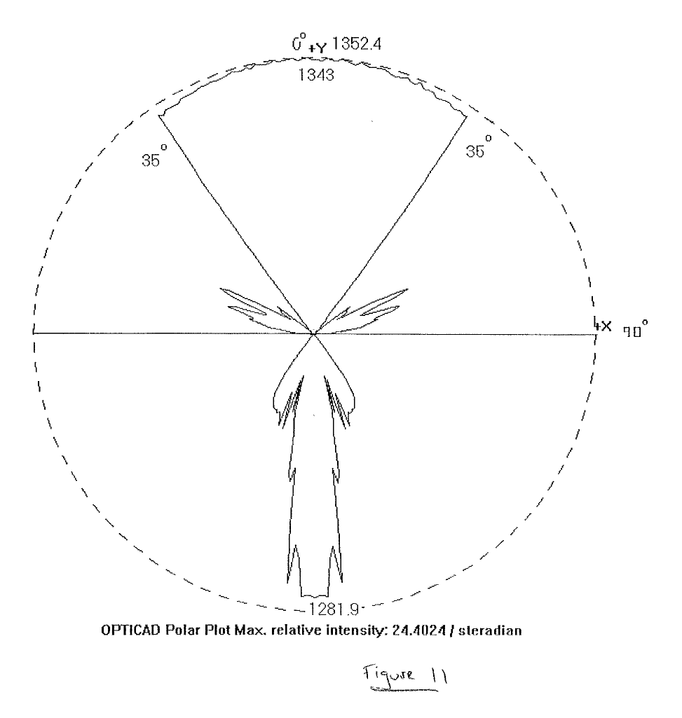

FIG. 11 is a polar plot of light distribution for the display device 10 of FIG. 1 in which the linear prisms 30 are multi-planar and symmetrical and have an apex angle of about 92 degrees and base angles of about 46 degrees. The transmitted light has about a 36 degree half width at the half luminance value. The central value for the transmitted light is about 1,343 candelas/lux/m² while the highest value is about 1,352.4 candelas/lux/m².

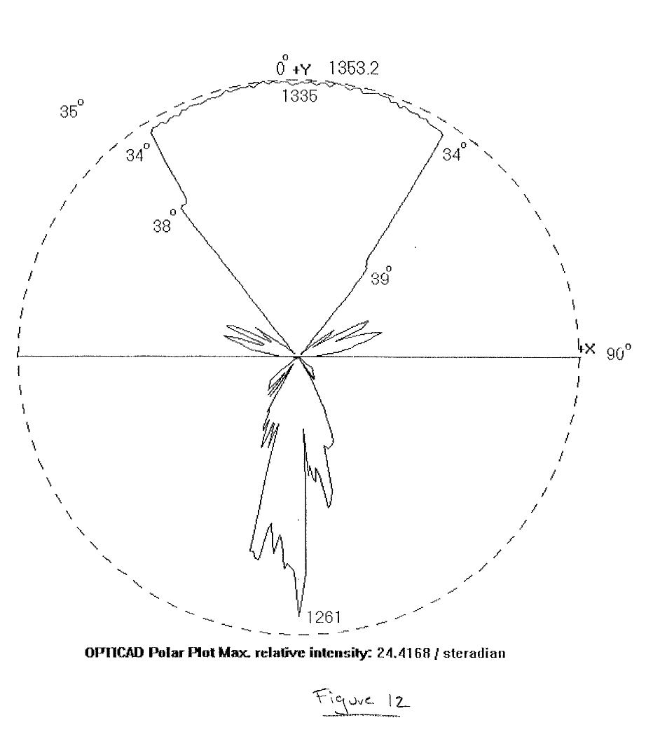

FIG. 12 is a polar plot of light distribution for the display device 10 of FIG. 1 in which the linear prisms are multi-planar and non-symmetrical and have an apex angle of about 99 degrees and base angles of about 49 degrees. The transmitted light has about a 38 degree half width at the half luminance value on the left side and about a 34 degree half width at the half luminance value on the right side. The central value for the transmitted light is about 1,335 candelas/lux/m² while the highest value is about 1,353 candelas/lux/m².

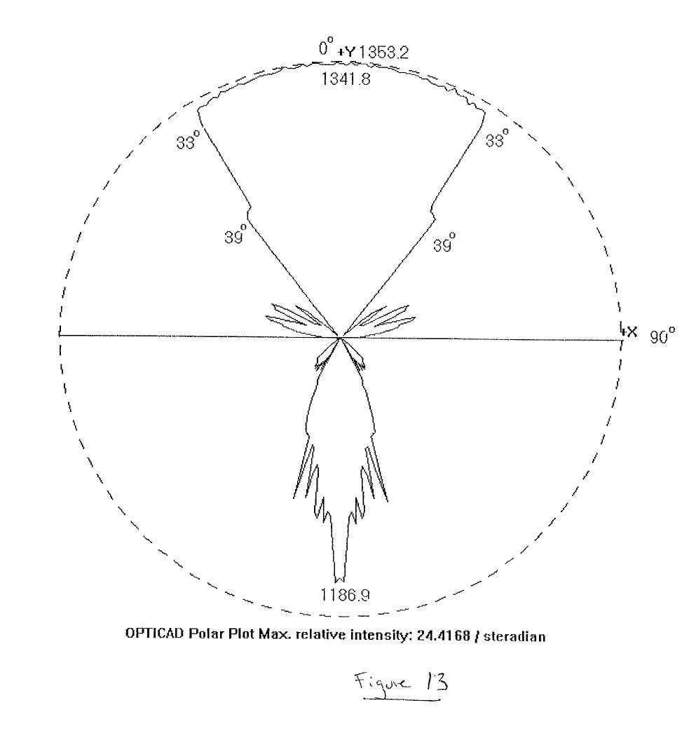

FIG. 13 is a polar plot of light distribution for the display device 10 of FIG. 1 in which the linear prisms are multi-planar and symmetrical and have an apex angle of about 100 degrees and base angles of about 50 degrees. The transmitted light has about a 39 degree half width at the half value. The central value for the transmitted light is about 1,341.8 candelas/lux/m² while the highest value is about 1,353.2 candelas/lux/m².

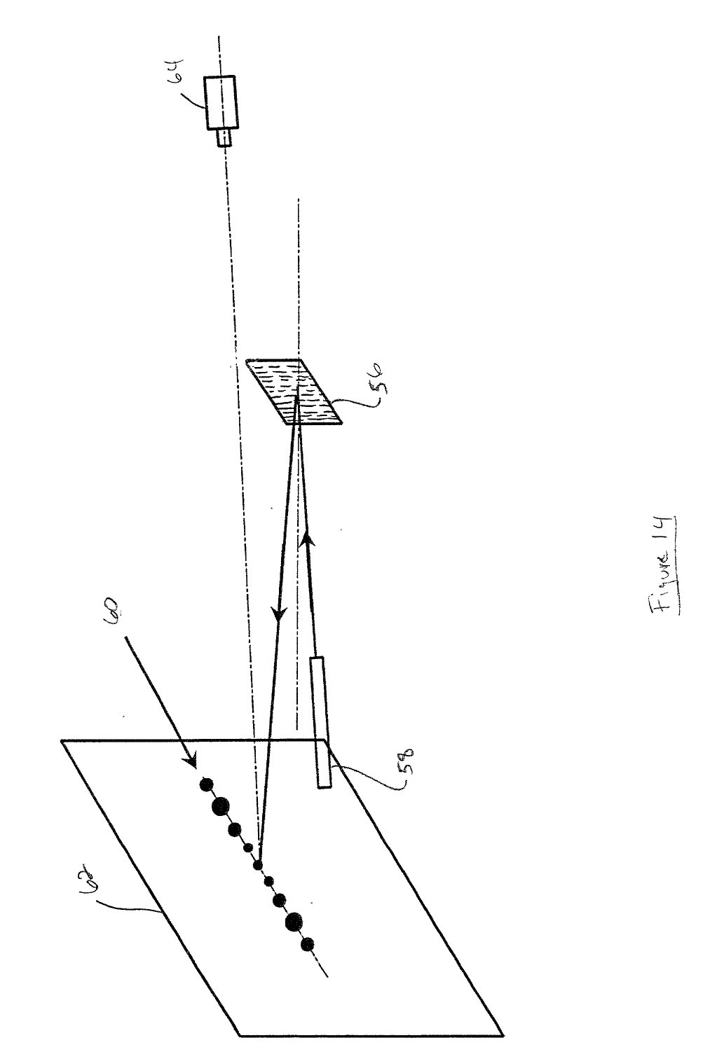

FIG. 14 illustrates a configuration for testing the optical performance of the linear prisms. As shown, a collimating film 56 having linear prisms is oriented substantially vertical and metalized on the prism side and hit with collimated light, such as from a laser 58. The metalized prisms face the screen 62. The reflected light impinges upon a screen 62 to form a diffraction pattern 60 which is recorded by a CCD camera 64.

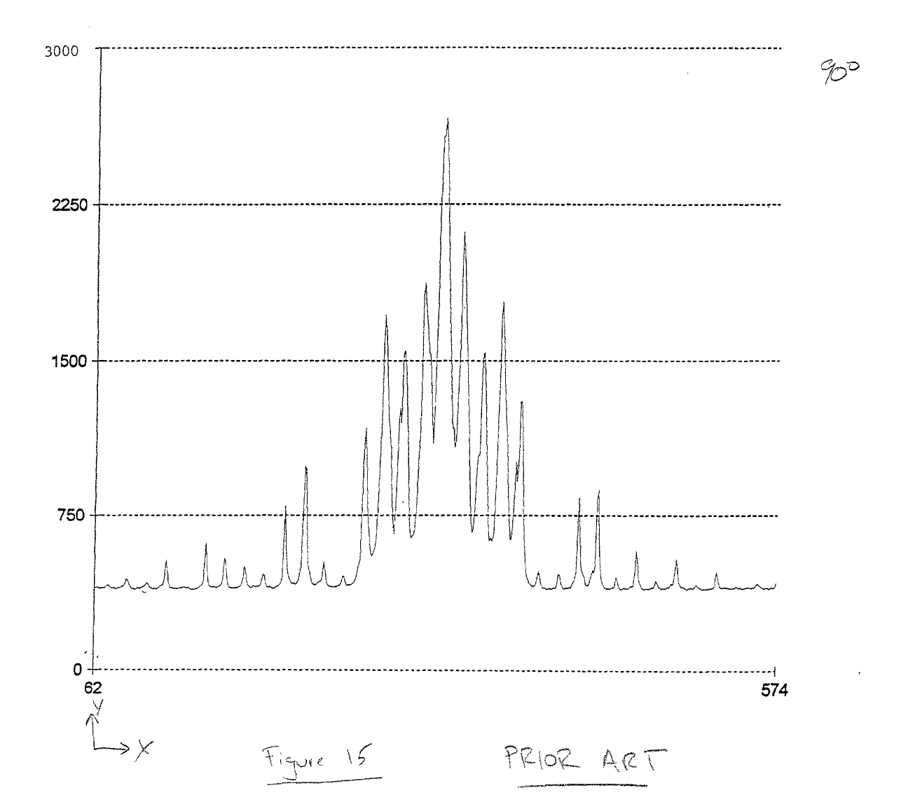

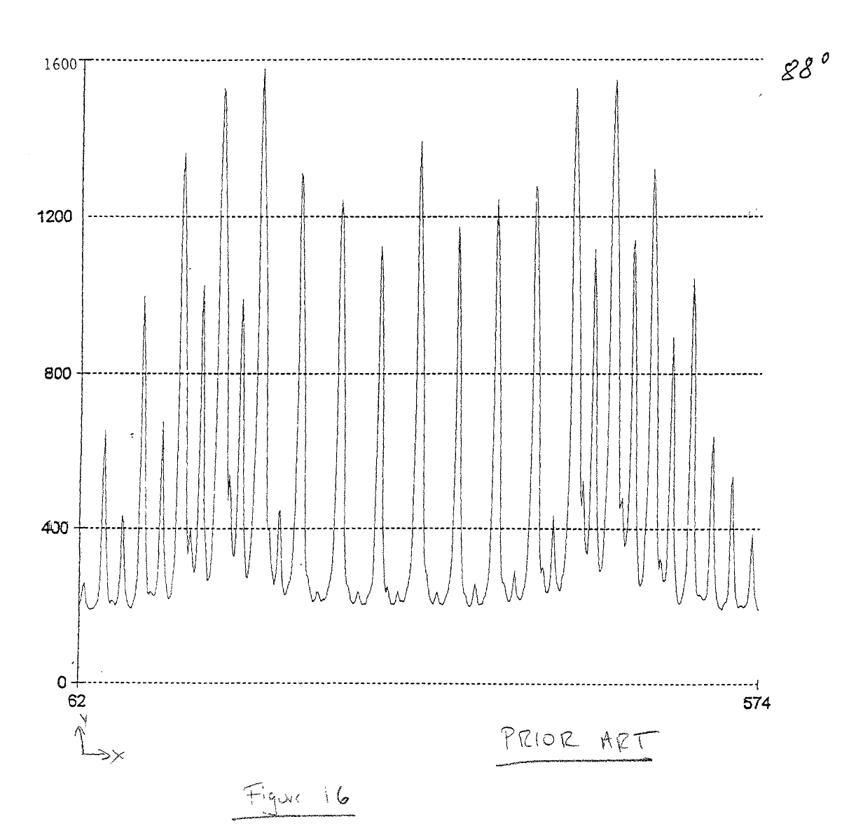

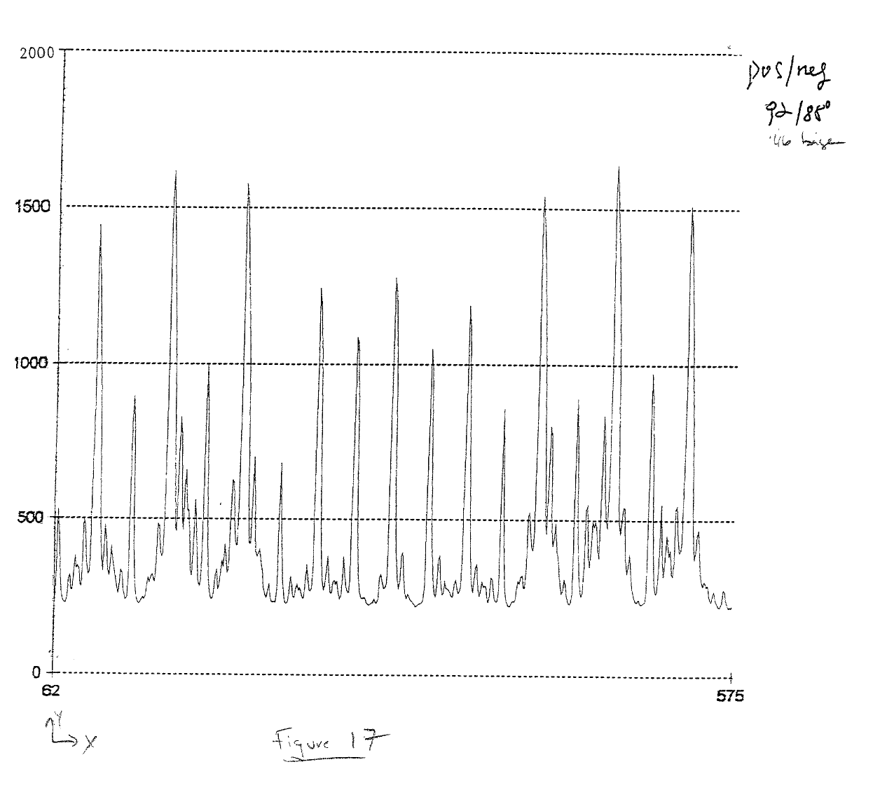

FIG. 15 is a plot illustrating the luminance (candelas/lux/m²) on the y axis versus the pixel position of the CCD for typical symmetric linear prisms having about 90 degree apex angles. FIG. 16 is a plot illustrating the luminance versus the pixel position for a plurality of symmetric linear prisms having about 88 degree apex angles. FIG. 17 is a plot illustrating the luminance versus the pixel position for a plurality of symmetrical linear prisms having multi-planar facets in which the base angles are about 46 degrees and the apex angles are about 92 degrees.

In any of the embodiments, the cross-sectional lengths and angles disclosed are for illustrative purposes only and can be modified to change light distribution through the prism to suit desired throughput requirements. In particular embodiments, the peak angle can have a value in the range of about 80 to 100 degrees. The angle between adjacent planar facets along the sides of the prism can be in the range of about 160 to 200 degrees. The base angle between the base plane and planar facet can be in the range of about 37 to 50 degrees. An exemplary pitch, or spacing between the prisms, is less than about 50 micrometers (1.96 mils).

While this invention has been particularly shown and described with references to embodiments thereof, it will be understood by those skilled in the art that various changes in form and details may be made therein without departing from the scope of the invention encompassed by the appended claims.

What is claimed is:

1. A sheeting having linear prisms comprising a cross section having a base, a first side, and a second side, wherein the first side includes a first planar surface and the second side includes a second planar surface and a third planar surface, the first, second, and third planar surfaces each having different cross-sectional lengths.

2. The sheeting of claim 1 wherein the first side includes the first planar surface extending from the base plane to a fourth planar surface, the fourth planar surface extending to the second planar surface at an apex of the prism.

3. The sheeting of claim 2, wherein each of the four planar surfaces has a different cross-sectional length.

4. A sheeting consisting of a cross section having a base plane and three planar facets.

5. The sheeting of claim 4, wherein each of the planar facets has a different cross-sectional length.

6. The sheeting of claim 4 wherein at least two of the planar facets have the same cross-sectional length.

7. A sheeting having linear prisms comprising:
a base plane;
a first planar facet extending from the base plane to an apex;
a second planar facet extending from the apex; and
a third planar facet extending from the second planar facet to the base plane.

8. The sheeting of claim 7 wherein each of the planar facets has a different cross-sectional length.

9. The sheeting of claim 1 wherein the second planar facet and the third planar facet have the same length.

10. A back light display device comprising:
a lighting device;
a waveguide that receives light radiating from the lighting device; and
a first plurality of linear prisms that redirect light from the waveguide in a predetermined direction, each of the linear prisms having a base and at least three planar surfaces.

11. The back light display device of claim 10 further comprising a diffuser disposed between the waveguide and the first plurality of linear prisms.

12. The back light display device of claim 10 further comprising a second plurality of linear prisms disposed adjacent to the first plurality of linear prisms.

13. A sheeting having linear prisms comprising:
a base plane;
a first planar facet extending from the base plane;
a second planar facet extending from the first planar facet to an apex;
a third planar facet extending from the apex; and
a fourth planar facet extending from the third planar facet to the base plane, wherein three of the first planar facet, the second planar facet, the third planar facet and the fourth planar facet include different cross-sectional lengths.

14. The sheeting of claim 13 wherein none of the planar facets have the same length.

15. A sheeting having linear prisms having a primary axis and at least four planar surfaces disposed along the primary axis, wherein at least three planar surfaces have different cross-sectional lengths.

16. A sheeting having prism arrays having a plurality of linear prisms each having a longitudinal axis, wherein each linear prism includes at least four planar surfaces disposed along the longitudinal axis, wherein at least three planar surfaces have different cross-sectional lengths.

17. A sheeting having linear prisms having a base, a first side and a second side, and a peak wherein the first side and the second side each includes two surfaces which meet at a dihedral angle of less than 180 gdegrees which are different and which intersect along a longitudinal axis of the prism.

18. A back light display device comprising:
a lighting device;
a waveguide that receives light radiating from the lighting device; and
a first plurality of linear prisms that redirect light from the waveguide in a predetermined direction, each of the linear prisms including at least four planar surfaces and said prisms project away from the interior of said device.

19. The back light display device of claim 18 further comprising a diffuser disposed between the waveguide and the first plurality of linear prisms.

20. The back light display device of claim 18 further comprising a second plurality of linear prisms disposed adjacent to the plurality of first linear prisms.

21. A light collimating film comprising a plurality of linear prisms wherein each prisms includes at least four planar surfaces disposed along a longitudinal axis of the linear prism wherein at least three planar surfaces have different cross-sectional lengths.

22. A method of forming a plurality of linear prisms comprising:
providing a base substrate; and
forming the plurality of linear prisms on the base substrate, each prism including a base, a first side, a peak, and a second side, wherein the first side includes a second planar surface and a third planar surface, the first, second, and third planar surfaces each having different cross-sectional lengths.

23. A method of forming a plurality of linear prisms comprising:
providing a base substrate; and
forming the plurality of linear prisms thereon, each prism consisting of a base plane and three planar surfaces.

24. A method of redirecting light comprising:
providing a light device that produces a plurality of light rays;
redirecting at least some of the light rays toward a linear prism; and
redirecting the at least some of light rays with the linear prism, the prism including a base plane, a first planar facet extending from the base plane to an apex, a second planar facet extending from the apex, and a third planar facet extending from the second planar facet to the base plane.
